(19) United States
(12) Patent Application Publication
(10) Pub. No.: US 2005/0286620 A1
(43) Pub. Date: Dec. 29, 2005

(54) Synchronous transmission in DSL communications systems

(75) Inventor: Chia-Ning Peng, Fremont, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/155,140

(22) Filed: Jun. 17, 2005

Related U.S. Application Data
(60) Provisional application No. 60/582,625, filed on Jun. 23, 2004.

(51) Int. Cl. H04L 5/16

(52) U.S. Cl. 375/222

(57) ABSTRACT

A multiple port digital subscriber line (DSL) modem for effecting DSL communications over bonded twisted-pair wire facilities is disclosed. The frame boundaries of DSL frames communicated by the modem from its ports are synchronized in time during DSL initialization by controlling the frame at which cyclic affices are appended. The cyclic affix has a known length, and the time delays among the various ports are known. Adjustment at the frame at which the cyclic affix is first applied can be accomplished by controlling the number of frames transmitted without the cyclic affix prior to the point of appending cyclic affices, according to the relative delay among the ports. Because the cyclic affix has a length that is a fraction of a frame, the relative frame timing can be adjusted by this fraction in this manner.

### CROSS-REFERENCE TO RELATED APPLICATIONS

This application claims priority, under 35 U.S.C. §119(e), of Provisional Application No. 60/582,625, filed Jun. 23, 2004.

### STATEMENT REGARDING FEDERALLY SPONSORED RESEARCH OR DEVELOPMENT

Not applicable.

### BACKGROUND OF THE INVENTION

This invention is in the field of digital communications, and is more specifically directed to signal-to-noise ratio improvement in such communications.

An important and now popular modulation standard for digital subscriber line (DSL) communications is Discrete Multitone (DMT) modulation. According to DMT technology, the available spectrum is subdivided into many subchannels (e.g., 256 subchannels of 4.3125 kHz). Each subchannel is centered about a carrier frequency that is phase and amplitude modulated, typically by Quadrature Amplitude Modulation (QAM), in which each symbol value is represented by a point in the complex plane; the number of available symbol values depends, of course, on the number of bits in each symbol. During initialization of a DMT communications session, the number of bits per symbol for each subchannel (i.e., the “bit loading”) is determined according to the noise currently present in the transmission channel at each subchannel frequency and according to the transmit signal attenuation at that frequency. For example, relatively noise-free subchannels may communicate data in ten-bit to fifteen-bit symbols corresponding to a relatively dense QAM constellation (with short distances between points in the constellation for a fixed average signal power), while noisy channels may be limited to only two or three bits per symbol (to allow a greater distance between adjacent points in the QAM constellation for a fixed average signal power). In extreme cases of very strong noise or very large signal attenuation, some sub-channels may not be loaded with any bits. In this way, DMT maximizes the data rate for each subchannel for a given noise condition, permitting high speed access to be carried out even over relatively noisy twisted-pair lines.

FIG. 1 illustrates the data flow in conventional DSL communications, for a given direction (e.g., downstream, from a central office “CO” to customer premises equipment “CPE”). Typically, each DSL transceiver (i.e., both at the CO and also in the CPE) includes both a transmitter and a receiver, so that data is also communicated in the opposite direction over transmission channel LP according to a similar DMT process. As shown in FIG. 1, the input bitstream that is to be transmitted, typically a serial stream of binary digits in the format as produced by the data source, is applied to constellation encoder 11 in a transmitting modem 10. Constellation encoder 11 fundamentally groups the bits in the input bitstream into multiple-bit symbols that are used to modulate the DMT subchannels, with the number of bits in each symbol determined according to the bit loading assigned to its corresponding subchannel, based on the characteristics of the transmission channel as mentioned above. Encoder 11 may also include other encoding functions, such as Reed-Solomon or other forward error correction coding, trellis coding, turbo or LDPC coding, and the like. The symbols generated by constellation encoder 11 correspond to points in the appropriate modulation constellation (e.g., QAM), with each symbol associated with one of the DMT subchannels. Following constellation encoder 11, shaping function 12 provides spectrum shaping (for example according to a specified power spectral density, or PSD) and derives a clip prevention signal included in the encoded signals to be modulated, to reduce the peak-to-average ratio (PAR) as transmitted as described in copending application Ser. No. 10/034,951, filed Dec. 27, 2001, published on Nov. 28, 2002 as U.S. Patent Application Publication No. 2002/0176509, incorporated herein by this reference.

The encoded symbols are applied to inverse Discrete Fourier Transform (IDFT) function 13, which associates each symbol with one subchannel in the transmission frequency band, and generates a corresponding number of time domain symbol samples according to the Fourier transform. As known in the art, cyclic insertion function 14 appends a cyclic prefix or suffix (generically, affix), to the modulated time-domain samples from IDFT function 13, and presents the extended block of serial samples to parallel-to-serial converter 15. In ADSL2+ and VDSL, cyclic prefix and suffix insertion, and transmitter windowing, are combined into a single cyclic insertion function 14, which preferably operates on the modulated data in parallel form as shown; in ADSL, cyclic insertion function 14 preferably follows serial-to-parallel conversion, and simply prepends a selected number of sample values from the end of the block to the beginning of the block. Following conversion of the time-domain signal into a serial sequence by converter 15, and such upsampling (not shown) as appropriate, digital filter function 16 then processes the digital datastream in the conventional manner to remove image components and voice band or ISDN interference. The filtered digital datastream signal is then converted into the analog domain by digital-to-analog converter 17. After conventional analog filtering and amplification (not shown), the resulting DMT signal is transmitted over a channel LP, over some length of conventional twisted-pair wires, to a receiving DSL modem 20, which, in general, reverses the processes performed by the transmitting modem to recover the input bitstream as the transmitted communication.

At receiving DSL modem 20, analog-to-digital conversion 22 then converts the filtered analog signal, after filtering by conventional analog filters and amplification (not shown), into the digital domain, following which conventional digital filtering function 23 is applied to augment the function of pre-conversion receiver analog filters (not shown). A time domain equalizer (TEQ) (not shown) may apply a finite impulse response (FIR) digital filter that effectively shortens the length of the impulse response of the overall channel that includes the transmission channel LP, the analog filters and amplifiers on the transmit and receive sides, and the digital filters on the transmit and receive sides. Serial-to-parallel converter 24 converts the datastream into a number of samples for application to Discrete Fourier Transform (DFT) function 27, after removal of the cyclic extension from each received block in function 25. At DFT function 27, the modulating symbols at each of the subchannel frequencies are recovered by reversing the IDFT performed by function 12 in transmission. The output of DFT function 27 is a frequency domain representation of the transmitted symbols multiplied by the frequency-domain response of the effective transmission channel and the transmit and receive filters, both analog and digital. Frequency-domain equalization (FEQ) function 28 divides out the frequency-domain response of the effective channel, recovering the modulating symbols. Constellation decoder function 29 then resequences the symbols into a serial bitstream, decoding any encoding that was applied in the transmission of the signal and producing an output bitstream that corresponds to the input bitstream upon which the transmission was based. This output bitstream is then forwarded to the client workstation, or to the central office network, as appropriate for the location.

The DMT communications process, such as shown in FIG. 1, provides excellent transmission data rates over modest communications facilities such as twisted-pair wires. However, competitive and customer demands of the industry apply continuing pressure to increase the data rate, reliability performance, and loop length of such communications.

As a result of such pressure, the use of “bonded” techniques in DSL communications has become popular. For example, fiber optic facility infrastructure continues to be implemented in many populous areas, typically realized in communications from the CO to an optical network unit (ONU) deployed near to a group of customers. DSL communication over twisted-pair wire facilities is then utilized for the relatively short remaining distances from the ONU to the CPE installations in that neighborhood. This architecture is often referred to as fiber-to-the-curb (“FTTC”). But because the communications provider typically owns or controls the ONU, and thus can control the transmission of signals over each of multiple DSL loops, techniques become available to the provider to optimize the communications among the multiple subscribers in that neighborhood.

FIG. 2a illustrates the architecture of a conventional FTTC DSL communications system. At central office CO1, routers 30a, 30b communicate with Internet service providers or other servers TELCO A, TELCO B, respectively. Routers 30a, 30b are each connected to and communicate with multiplexer/demultiplexer 32, which transmits and receives communications signals over fiber optic facility FO accordingly, as shown. The particular modulation or communication standard used over fiber optic facility FO will depend on the particular installation, but typically follows a standard such as the SONET standard or the like. At the opposite end of fiber optic facility FO (generally via other network elements such as add/drop multiplexers, and the like) is optical network unit ONU1. In this conventional arrangement, optical network unit ONU1 includes multiplexer/demultiplexer 34, which receives and routes the various communications channels carried by fiber optic facility FO to the appropriate modem or modem port, for eventual communication with corresponding customer premises equipment installations. In this example, optical network unit ONU1 includes multiple-port DSL modem 35, which includes support for four modem ports 35₀ through 35₃; each modem port 35₀ through 35₃ communicates with a respective customer premises equipment (CPE) installation 42₀ through 42₃, respectively, over a corresponding twisted-pair wire facility 40₀ through 40₃. An example of a conventional chipset useful in such a multiple-port DSL modem 35 is the AC6 ADSL infrastructure chipset available from Texas Instruments Incorporated.

In the conventional example of FIG. 2a, a single service provider typically controls optical network unit ONU1, regardless of the source or destination of the traffic being carried. As such, the communications carried out by optical network unit ONU1 over twisted-pair wire facilities 40₀ through 40₃ can be coordinated, and twisted-pair wire facilities 40₀ through 40₃ can be “bonded” into a single physical binder 40. Optimization techniques for controlling the communication of DSL signals over twisted-pair wire facilities 40₀ through 40₃ become applicable. One example of such an optimization technique is described in copending and commonly assigned application Ser. No. 11/003,308, filed Dec. 2, 2004, incorporated herein by this reference.

Bonded DSL communications can also be implemented in a conventional CO/CPE deployment, in which twisted-pair wire is used for the entire loop length from the CO to the CPE. FIG. 2b illustrates such an implementation, using the same reference numerals for like elements as in FIG. 2a. In this example, central office installation CO2 includes routers 30 (e.g., routers 30₁ and 30₂) that communicate with Internet service providers or other data sources and destinations in the conventional manner, and that are each connected to a corresponding modem port 35₀ through 35₃ of DSL modem 35. Also in this example, as in the case of FIG. 2a, each modem port 35₀ through 35₃ communicates with a respective customer premises equipment (CPE) installation 42₀ through 42₃, respectively, over a corresponding twisted-pair wire facility 40₀ through 40₃. And because a single central office installation CO2 and modem 35 supports these multiple loops, the communications over twisted-pair wire facilities 40₀ through 40₃ can be coordinated by DSL modem 35, with optimization techniques applied as desired.

By way of further background, techniques for improving the signal-to-noise ratio (SNR) of DSL communications, by overcoming noise such as far-end crosstalk (FEXT) are described in Ginis et al., “Vectored Transmission for Digital Subscriber Line Systems”, Journal on Selected Areas in Communications, Vol. 26, No. 5 (IEEE, June 2002), pp. 1085-1104; and Ginis et al., “Vectored-DMT: A FEXT Canceling Modulation Scheme for Coordinating Users”, presented at IEEE International Conference on Communication, Vol. 1 (IEEE, June 2001), pp. 305-309. According to these approaches, joint signal processing among the multiple neighboring loops can be performed so that FEXT noise over the multiple loops will cancel, thus improving the SNR of all of the loops.

By way of still further background, various standards for DSL transmission are known in the art. Examples of standards of current relevance in the industry include Asymmetric digital subscriber line transceivers 2 (ADSL2), ITU-T Recommendation G.992.3 (International Telecommunications Union, July 2002); and Asymmetric Digital Subscriber Line (ADSL) transceivers—Extended bandwidth ADSL2 (ADSL2+), Recommendation G.992.5 (International Telecommunications Union, May 2003).

### BRIEF SUMMARY OF THE INVENTION

It is therefore an object of this invention to provide a method and system for synchronizing discrete multitone (DMT) modulated signals communicated over multiple adjacent physical communications facilities.

It is a further object of this invention to provide such a method and system in which noise cancellation techniques among the multiple facilities can be applied.

It is a further object of this invention to provide such a method and system that can be readily implemented according to standard digital subscriber line (DSL) standard initialization routines.

Other objects and advantages of this invention will be apparent to those of ordinary skill in the art having reference to the following specification together with its drawings.

The present invention may be implemented into a DSL modem, for example deployed at a central office (CO) or optical network unit (ONU), that supports multiple DSL loops in a “bonded” DSL arrangement. The DSL modem includes multiple modem ports that transmit DMT frames within a frame structure, and in which the frame boundaries are staggered among the ports in a fixed relationship. Each DMT frame over each loop is transmitted along with a cyclic extension, or affix (prefix, suffix, or mid-frame affix), to reduce intersymbol interference (ISI) in the known manner. During a first portion of an initialization or training sequence for a DSL communication session, DMT frames are transmitted without cyclic extensions; cyclic extensions are then enabled and included in a second subsequent portion of the initialization sequence. During initialization or training of a DSL communication session for a DSL loop, according to the invention, the duration of the first portion of the training sequence, prior to enabling cyclic extensions, is determined according to the relative delay of that loop relative to other loops so that the communications are frame-synchronized with one another once cyclic extensions are enabled, including in actual payload transmissions. Cross-correlation of noise, such as far-end crosstalk, among the bonded loops is therefore improved, improving the performance of noise cancellation techniques over all of the bonded loops.

### BRIEF DESCRIPTION OF THE SEVERAL VIEWS OF THE DRAWING

FIG. 1 is a data flow diagram, in block form, illustrating conventional DSL communications functions at the transmitter and receiver.

FIGS. 2a and 2b are electrical diagrams, in block form, illustrating conventional bonded DSL deployment architectures.

FIG. 3 is an electrical diagram, in block form, of a multiple-port DSL modem constructed according to the preferred embodiment of the invention.

FIG. 4 is an electrical diagram, in block form, of a digital transceiver constructed according to the preferred embodiment of the invention.

FIG. 5 is a timing diagram illustrating the relative timing of DSL frames communicated over neighboring loops in a binder, such frames including cyclic affices, and shown prior to frame synchronization according to the preferred embodiment of the invention.

FIG. 6 is a timing diagram illustrating the incorporating of extra frames with a cyclic affix in order to frame-synchronize two exemplary ports supported by the modem of FIG. 3.

FIG. 7 is a timing diagram illustrating the sequence of events in initialization of a DSL communications session, according to the preferred embodiment of the invention.

FIG. 8 is a flow diagram illustrating the initialization of the DSL modem of FIG. 3 in effecting frame synchronization according to the preferred embodiment of the invention.

### DETAILED DESCRIPTION OF THE INVENTION

The present invention will be described in connection with its preferred embodiment, namely as implemented into a central office (CO) or optical network unit (ONU) in a digital subscriber line (DSL) context, as it is contemplated that this invention will be especially beneficial when utilized in such an application. However, it is also contemplated that this invention may also be used in, and benefit, other applications, especially those in which a cyclic prefix or suffix is used in connection with frame-based communications over multiple facilities. Accordingly, it is to be understood that the following description is provided by way of example only, and is not intended to limit the true scope of this invention as claimed.

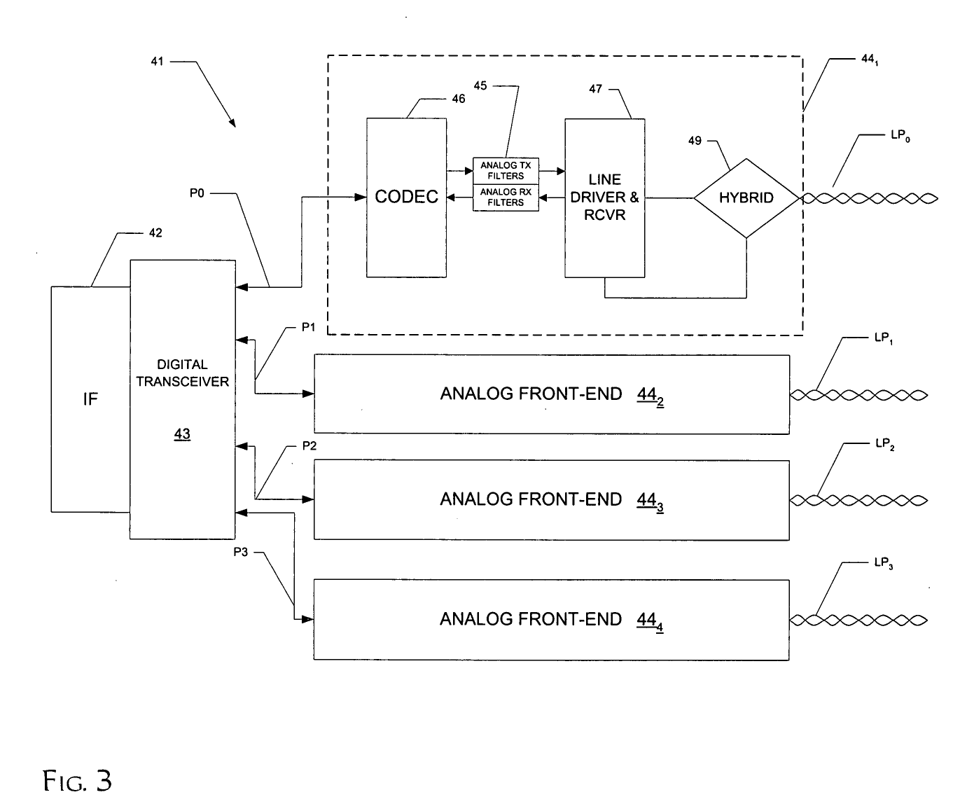

FIG. 3 illustrates an exemplary DSL modem 41, according to the preferred embodiment of the invention. In this embodiment of the invention, DSL modem 41 includes digital transceiver 43, which supports four communication ports P0 through P3. As such, DSL modem 41 both transmits and receives signals over four associated communications facilities, namely twisted-pair facilities, or transmission loops, LP₀ through LP₃, corresponding to ports P0 through P3, respectively. Digital transceiver 43 of modem 41 is coupled to host interface 42, by way of which it communicates with a host computer, network switch fabric, network element such as a router, or the like, depending on the application. Digital transceiver 43 is connected to multiple analog front ends 44, which in this example are represented as four instances of analog front ends 44₁ through 44₄, as shown in FIG. 3.

Each of analog front ends 44₁ through 44₄ are similarly configured, and each support a DSL link over a corresponding transmission loop LP₀ through LP₃, respectively. Each analog front end 44 includes hybrid circuit 49, which a conventional circuit that is connected to its transmission loop LP, and that converts the two-wire arrangement of the twisted-pair facility to dedicated transmit and receive lines connected to line driver and receiver 47, considering that bidirectional signals are communicated over communications loop LP by DSL modem 41. Line driver and receiver 47 is a high-speed line driver and receiver for driving and receiving ADSL signals over twisted-pair lines. Line driver and receiver 47 is bidirectionally coupled to coder/decoder (“codec”) circuit 46 via analog transmit and receive filters 45. Codec 46 in analog front end 44 performs the conventional analog codec operations on the signals being transmitted and received, respectively. Examples of conventional devices suitable for use as analog front end 44 according to the preferred embodiment of the invention include the TNETD7122 and TNETD7123 integrated analog front end devices available from Texas Instruments Incorporated.

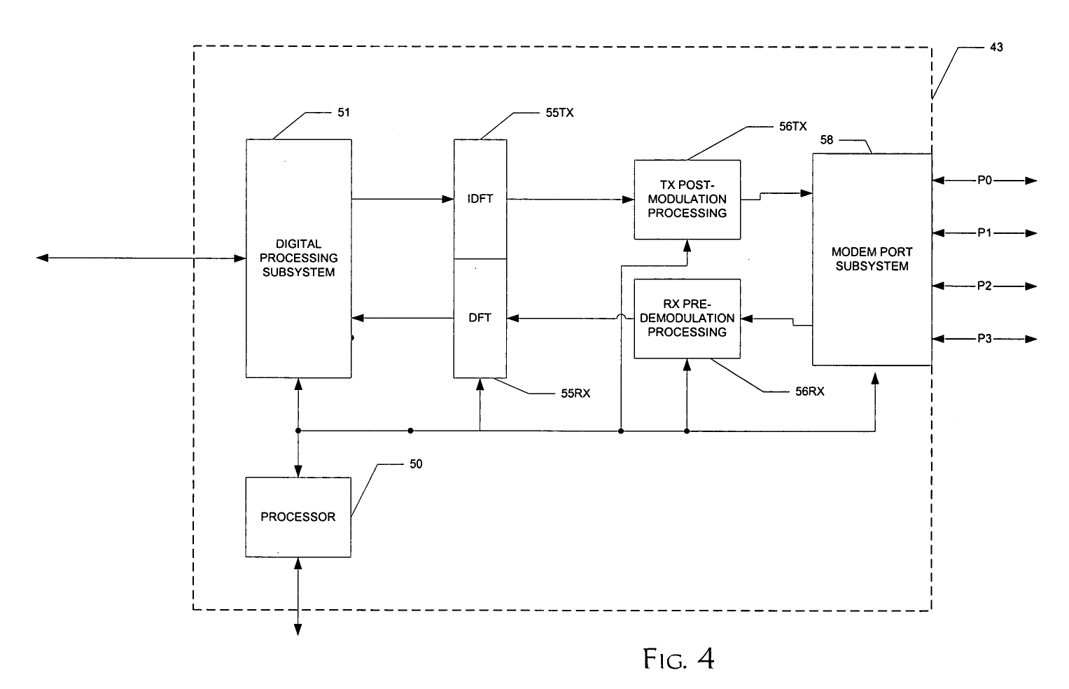

FIG. 4 illustrates an exemplary architecture for digital transceiver 43 in modem 41 according to this embodiment of the invention. As shown in FIG. 4, digital transceiver 43 includes digital processing subsystem 51, which is coupled to the host side of transceiver 43, and which performs byte-level and bit-level processing of unmodulated digital data (prior to modulation or after demodulation). For example, on the transmit side, digital processing subsystem 51 would perform such functions as framing, forward error correction (FEC), and interleaving, trellis coding, and constellation mapping. Conversely, digital processing subsystem 51 reverses these processes on received demodulated signals, in addition to applying the FEQ functionality described above. Transceiver 43 also includes IDFT modulation function 55TX, which modulates the processed signals from digital processing subsystem 51 to be transmitted according to the desired DMT modulation; conversely, DFT demodulation function 55RX applies DFT demodulation to received DMT signals, according to the desired DMT modulation applied by the transmitter of such signals. According to the preferred embodiment of the invention, subsystems 51, 55TX, 55RX may be realized by custom logic circuitry, or by programmable logic such as one or more digital signal processor (DSP) cores, having sufficient computational capacity and complexity to perform much of the digital processing in the encoding and modulation (and demodulation and decoding) of the signals communicated via digital transceiver 43. Transceiver 43 may also include processor 50, which may or may not also be a DSP processor, along with its associated memory resources including both program and data memory, to assist these functions, and to effect the initialization, or training, processes described below in connection with the operation of the preferred embodiment of the invention.

Digital transceiver 43 also preferably includes other post-modulation functionality 56TX, for performing such functions as appending of a cyclic extension, or cyclic affix (for purposes of this description, the terms “cyclic extension” and “cyclic affix” may be and are used interchangeably), to the output of each IDFT modulation for each port, and applying the appropriate filter functions to the signals to be transmitted. On the receive side, pre-modulation processing functionality 56RX applies the appropriate filter functions to receive signals, and includes such functions as time domain equalization, removal of any cyclic affix, and the like. Post-modulation processing functionality 56TX and pre-demodulation processing functionality 56RX may be executed by DSP resources within transceiver 43 according to the corresponding software routines, as known in the art, or alternatively may be realized as separate hardware resources as suggested by FIG. 4. Modem port subsystem 58 is also provided within digital transceiver 43, for coupling processing functions 56TX, 56RX to one or more analog ports within the modem in which digital transceiver 43 is implemented, for example as shown in FIG. 3. As evident from this description and FIG. 4, each of the analog ports serves as an output port in the transmit direction, and as an input port in the receive direction.

It is contemplated that those skilled in the art having reference to this specification will be readily able to realize digital transceiver 43 to provide such functions as described herein according to the preferred embodiment of the invention. This description of the functionality of digital transceiver 43 is contemplated to merely provide sufficient information that such realization of the actual circuitry can be accomplished without undue experimentation.

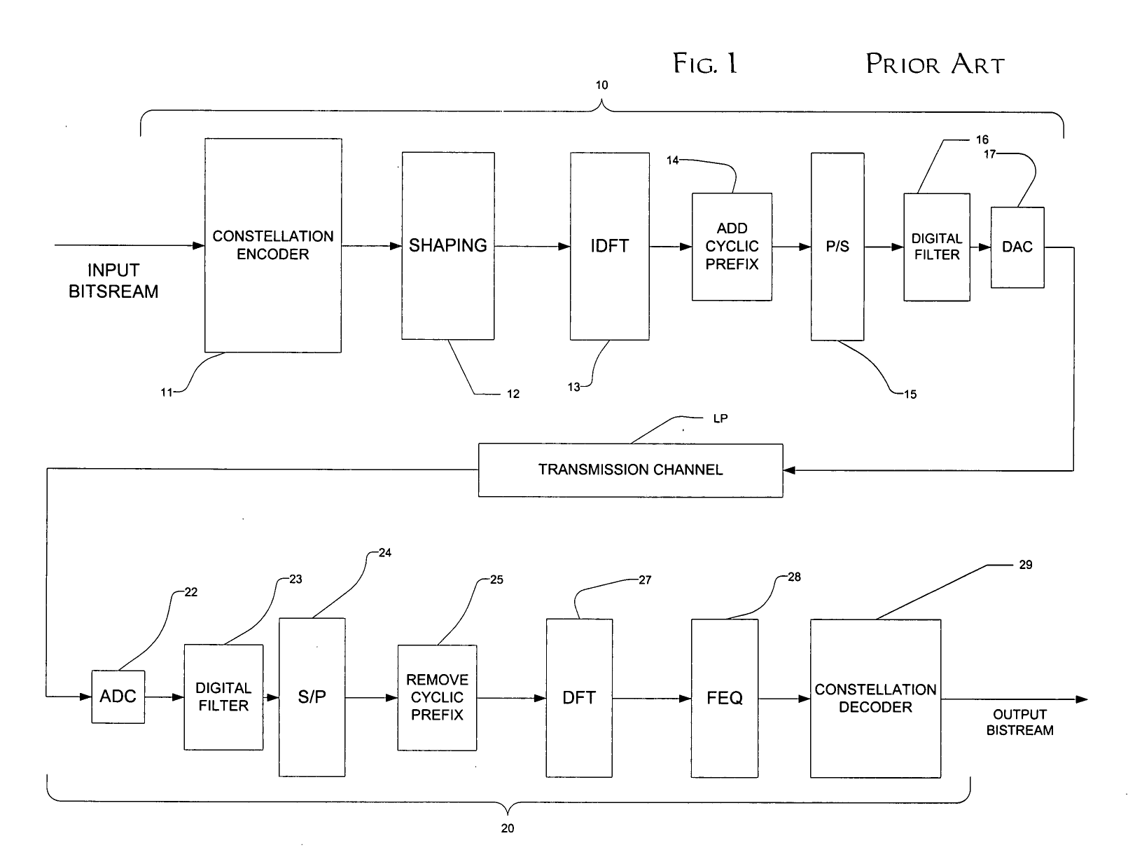

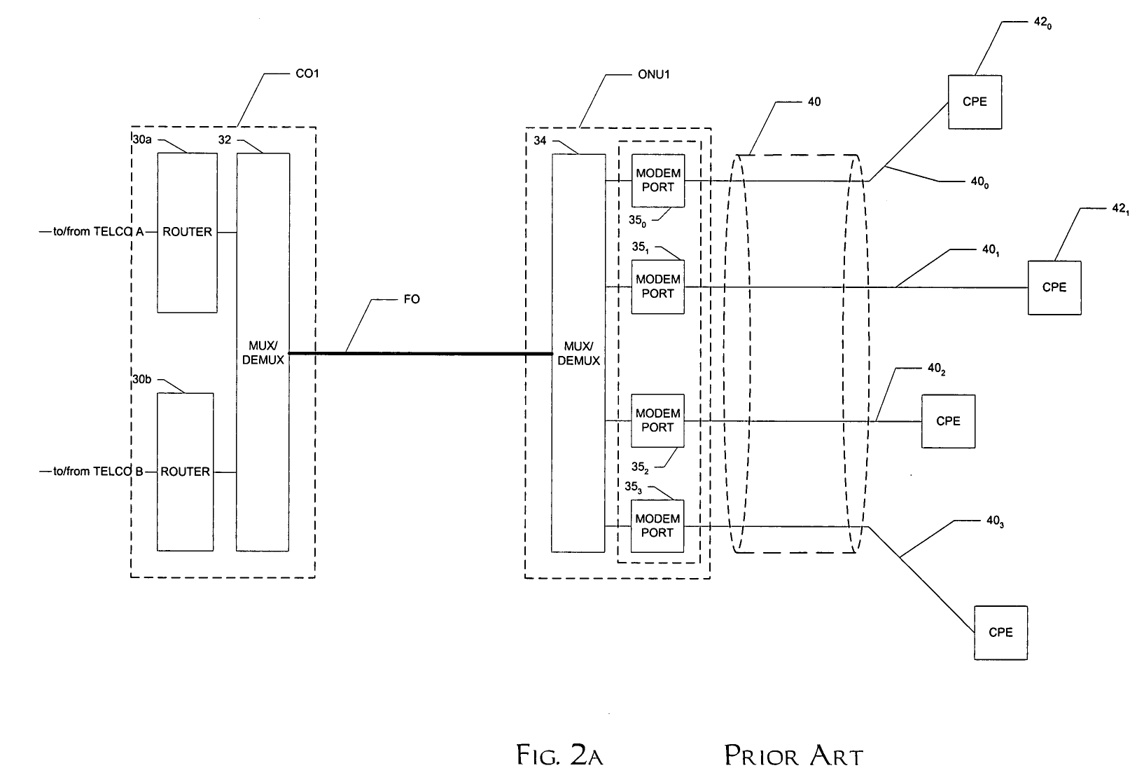

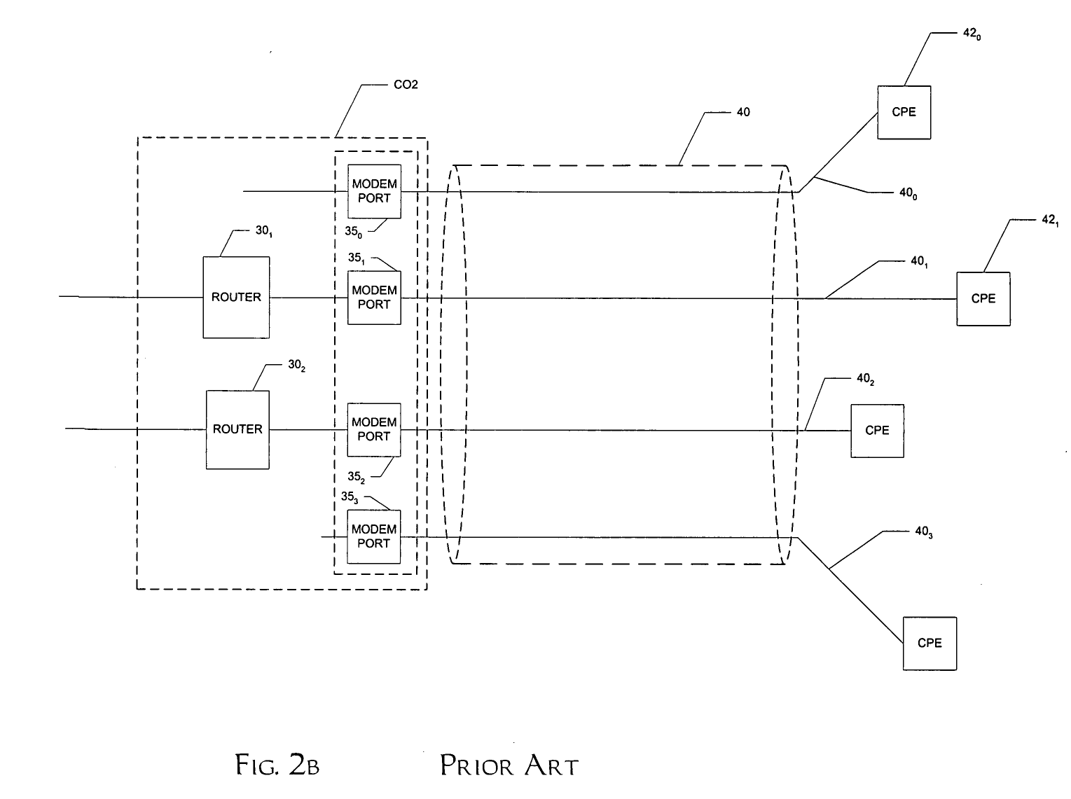

As mentioned above relative to FIG. 1, the insertion of a cyclic affix (prefix, suffix, or mid-frame affix) into a time domain signal in the form of a discrete sample stream is known. As known in the art, the insertion of the cyclic affix begins from a certain point in the initialization sequence of a DSL communications session, prior to which frames are transmitted and received that do not have a cyclic affix or extension. The cyclic affix typically consists of the appending of a copy of a portion of the symbol to the symbol itself to form an extended symbol. In the most common case of a cyclic prefix, the last L samples of a time domain symbol for a given subchannel are copied and prepended to the beginning of the symbol prior to transmission. By extending the symbol in this manner, intersymbol interference (ISI) and interchannel intereference (ICI) caused by non-ideal channel impulse response characteristics are greatly reduced, as known in the art. The appending of the cyclic affix may either be performed on a subchannel-by-subchannel basis, or over all subchannels in parallel after IDFT modulation as is preferred for communications carried out for an architecture such as that illustrated in FIG. 1.

It has been observed, according to this invention, that the length of the cyclic affix according to important DSL communications standards is fixed, and as such has a relationship to the frame length. For example, according to the standard Asymmetric digital subscriber line transceivers 2 (ADSL2), ITU-T Recommendation G.992.3 (International Telecommunications Union, July 2002), incorporated herein by this reference, the cyclic prefix is expressed as one-eighth of the number of subchannels, which corresponds to one-sixteenth of the length of the data symbol. Accordingly, for the case of N samples in a data symbol, the cyclic prefix length L is N/16. And taken over the length of a frame of an arbitrary number of symbols in which each symbol is extended by a cyclic prefix, the cumulative time duration of the cyclic prefices in that frame is one-sixteenth of the data frame period, in this example. Of course, other communications standards may have other fractional relationships between the cyclic affix length and overall symbol and frame length.

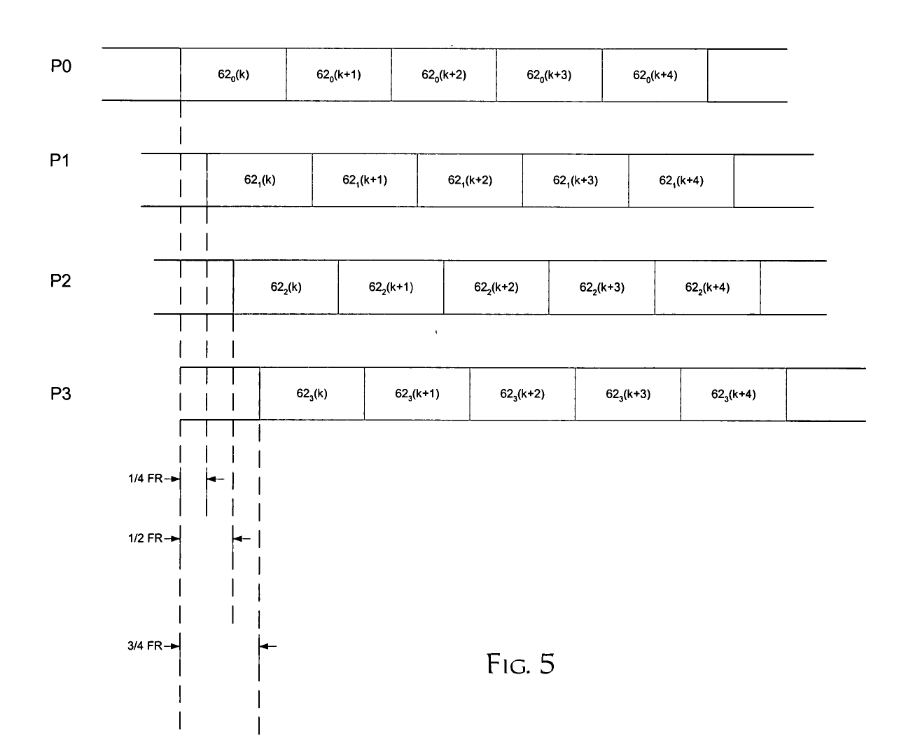

Referring back to FIG. 3, the multiple ports of multi-port DSL mode 41, according to the preferred embodiment of the invention, have a fixed frame synchronization relationship relative to one another at such times, such as during a first portion of the initialization sequence, at which cyclic extensions are not enabled. This time relationship may either be enforced by design for efficiency of operation (e.g., so that digital transceiver 43 may sequentially process data channels, which may be received in time-multiplexed fashion), or may be measured during initialization or normal operation. For example, referring to FIG. 5, using port P0 as a reference, frame 62₁(k) port P1 starts at a temporal delay of one-fourth of a frame relative to a corresponding frame 62₀(k) from port P0, frame 62₂(k) generated from port P2 is at a delay of one-half of a frame relative to corresponding frame 62₀(k) from port P0, and frame 62₃(k) is generated from port P3 at a delay of three-fourths of a frame relative to corresponding frame 62₀(k) from port P0. These time delay relationships continue over the entire sequence of frames 62(k) to 62(k+4), as shown in FIG. 5. Beginning with a second portion of the initialization sequence and during the communication of payload data, the ports will have also have a fixed frame synchronization relationship relative to one another, although the particular relationship after cyclic extensions are included may differ from the relationship prior to cyclic extension enabling.

As mentioned above, it is known that communications noise among DSL loops in a common binder or DSL plant cross-correlate with one another so that, assuming synchronization in time of the communications, noise cancellation techniques may be applied. In DSL modem 21 according to this preferred embodiment of the invention, however, the multiple ports are necessarily delayed in time relative to one another, especially after cyclic extensions are enabled on all ports. But also according to this invention, the known relationship of the length of cyclic affices to the frame length, and the known fractional frame length by which the addition of a cyclic affix extends the overall frame length, are used to time-synchronize communications frames among the multiple DSL loops after cyclic extensions are enabled, as will now be described.

As known in the art, and as described in the above-mentioned G.992.3 standard, initialization of a DSL communications session requires the transmission and receipt of various patterns of known frames, to effect such initialization functions as handshake procedures, channel discovery, transceiver training, channel analysis, and exchange of transmission parameters between transceivers, in the general sense. Following initialization, actual payload data are then communicated during the normal operation, referred to as “showtime”. At a known point toward the end of the initialization process, the transmitting transceiver will begin inserting the cyclic affix into each data frame. For example, according to the G.992.3 standard, the cyclic prefix is first transmitted at the beginning of the channel analysis phase.

According to this invention, time synchronization of frames during initialization after cyclic extensions are enabled and of data frames during “showtime”, is accomplished by adjusting the frame at which the cyclic affix is first applied on a port-by-port basis. In the example of FIG. 5, insertion of the cyclic affix would be delayed for port P3 relative to the other ports (conversely, advanced for ports P0, P1, P2 relative to port P3) by a number of frames corresponding to the relative time delay of the ports relative to one another at the CO or ONU. For the example of FIG. 5, and for the case in which the cyclic affix is one-sixteenth of a frame length, and under the G.992.3 standard in which the cyclic affix is initiated at the beginning of the channel analysis phase, insertion of the cyclic prefix at channel analysis at port P0 must be advanced twelve frames (or more generally, advanced by 12+16n frames for any integer n, or in other words, 12 modulo-16 frames) relative to that of port P3 so that the frames will align in time after cyclic extension is enabled on both ports P0 and P3. Insertion of the cyclic prefix at ports P1 and P2 must be advanced 8 modulo-16 frames and 4 modulo-16 frames, respectively, relative to that of port P3. By advancing the cyclic prefix insertion for all three ports P0 through P2 in this manner, all four ports P0 through P3 will be frame-synchronous after cyclic extension is enabled.

In summary, as mentioned above, initialization of a DSL communications session on any one of ports P0 through P3 includes a first portion in which frames are transmitted without cyclic extensions, and a second portion in which frames are transmitted with cyclic extensions. In either case, as specified in the relevant DSL standard, these initialization sequences are relatively constrained. According to the preferred embodiments of the invention, therefore, time synchronization among the various ports for frames after cyclic extensions have been enabled is accomplished by intelligently choosing the number of frames in the first portion of the initialization sequence on the multiple ports relative to one another, in effect causing a different number of frames without cyclic extensions to be transmitted from the different ports. Because the different numbers of frames are selected with respect to the known time delays among the ports, however, the transmitted frames with cyclic extensions will be frame-synchronized with one another.

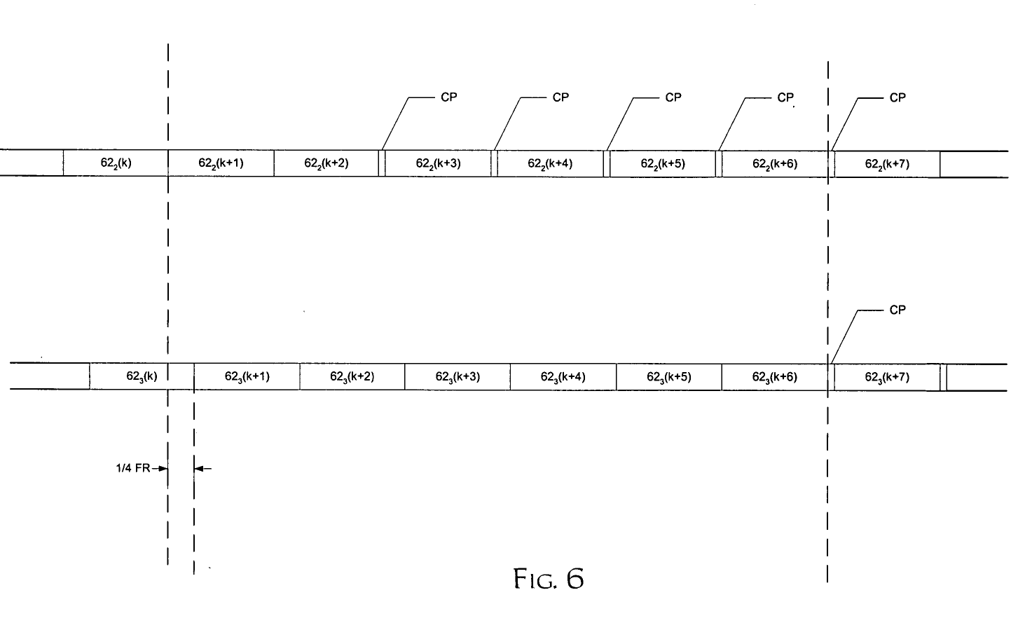

FIG. 6 illustrates an example of this delay and the initiation of cyclic prefices for ports P2 and P3, by way of an example of the preferred embodiments of the invention. Those of ordinary skill in the art will readily realize that the initialization of DSL communication sessions over the multiple ports supported by a single multiple-port DSL modem 21 will seldom, if ever, be time synchronous as shown in FIG. 6. However, the example of FIG. 6 illustrates a mechanism by way of which frame synchronization can occur. As will be described in further detail below, according to this invention, each port supported by DSL modem 21 will be separately initialized, with the particular frame at which the cyclic prefix is initiated being selected according to the port identity and its temporal relationship with the other ports before the initiation of cyclic extensions. As such, when more than one port are in “showtime”, their frames will be time-synchronized.

As shown in FIG. 6, at earlier stages of this sequence, transmitted frames 622 from port P2 begin one-fourth of a frame earlier than corresponding frames 623 from port P3. For example, frame 62₂(k+1) from port P2 leads corresponding frame 62₃(k+1) from port P3 by one-fourth frame. According to this invention, however, cyclic prefices CP are added into the frames from port P2 prior to such time as they are added into frames from port P3. In this specific example, because the length of each cyclic prefix instance CP is one-sixteenth of a frame, frame synchronization between ports P2, P3 is achieved if four (or more precisely, 4 modulo-16, or 4+16n for any integer n) additional frames 622 from port P2 receive cyclic prefix CP, relative to frames 623 from port P3. As such, in this example, cyclic prefix CP is first prepended to frame 62₂(k+3) from port P2, while cyclic prefix CP is first prepended to frame 62₃(k+7) from port P3. In other words, frames 62₂(k+3) through 62₂(k+6) from port P2 have cyclic prefices CP, while corresponding frames 62₃(k+3) through 62₃(k+6) from port P3 do not. As a result of the four extra frames 62₂(k+3) through 62₂(k+6) from port P2 having one-sixteenth frame long cyclic prefices CP, the frames from ports P2, P3 are frame synchronous with one another for each frame beginning with frames 62₂(k+7), 62₃(k+7). Noise cancellation techniques can then be applied to reduce random or Gaussian noise appearing on frames at both ports, as previously described.

According to the preferred embodiment of the invention, as will be described below, the act of advancing the frame at which the cyclic prefix is applied to transmitted frames is accomplished somewhat indirectly. For example, by reducing the number of transmitted frames that do not have a cyclic prefix from in advance of the point at which the cyclic prefix is first applied, one can effectively advance the frame at which the cyclic prefix is applied. Of course, depending on the particular standard or protocol for initialization or transmission, it may be possible to directly advance or delay the application of the cyclic affix to the transmitted frames, to achieve the same result.

According to many conventional ADSL standards, including the above-referenced G.992.3 standard, the initialization sequence includes various frame types that are transmitted between the CO (or ONU, as the case may be) and the CPE to effect the various initialization functions prior to channel analysis (i.e., initiation of cyclic affices), including channel discovery and transceiver training. And at least one of these sequences include a variable number of frames. According to the preferred embodiment of the invention, one of the initialization sequences involving a variable number of frames is used to select the frame at which the cyclic affix is first applied, based on the temporal relationship among multiple ports, so that once the cyclic affices are enabled, including during “showtime”, the data frames of the associated loops are frame-synchronous with one another.

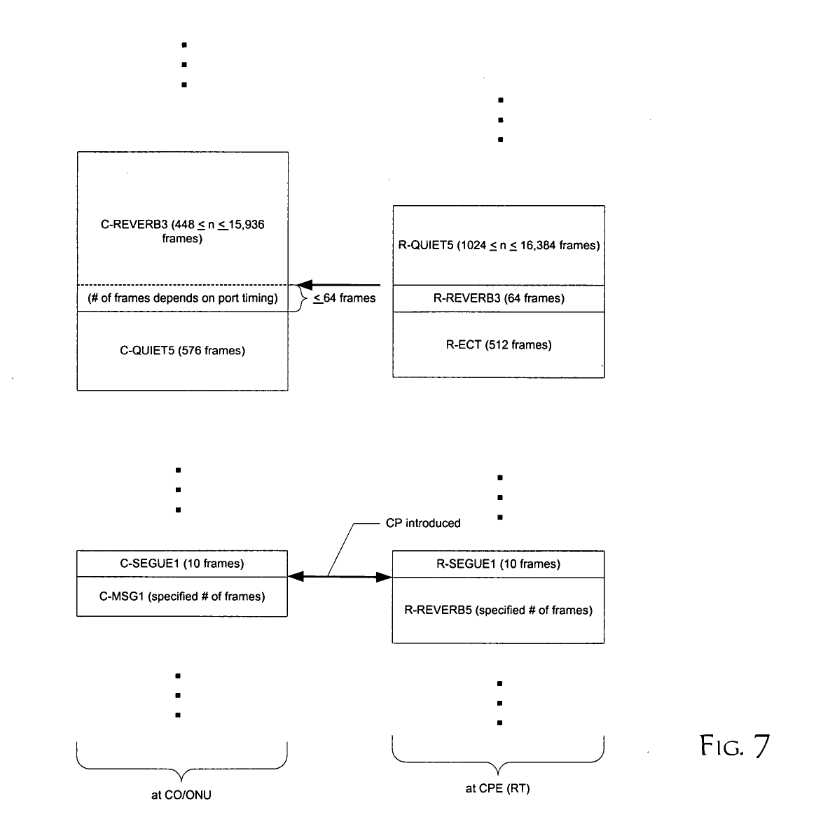

FIG. 7 illustrates a portion of the initialization sequence, specifically a portion of the transceiver training sequence as carried out between a CO or ONU, as the case may be, and a CPE installation (also referred to in the standard as the remote terminal, or RT), under the above-incorporated G.992.3 ADSL standard. During one part of the transceiver training phase under this standard, the CO (or ONU) is transmitting the C-REVERB3 sequence, which is a pseudo-random data sequence that is used by the CPE (RT) to perform downstream channel estimation. The number of frames of the C-REVERB3 sequence that are transmitted is variable between as few as 448 frames and as many as 15,936 frames. During this time, no cyclic prefix is included in the transmission, in either direction. And also during this time, the CPE (RT) is transmitting the R-QUIET5 sequence, which is an effectively zero-energy sequence of variable length between 1024 and 16,384 frames. The R-QUIET5 sequence is essentially a null transmission, continuing until the CPE (RT) completes its downstream channel estimation, which the CPE (RT) communicates to the CO(ONU) by transmitting the R-REVERB3 sequence for a duration of 64 frames.

According to the G.992.3 standard, therefore, the transition from the R-QUIET5 sequence and the R-REVERB3 sequence is a sharp signal, indicating in this case that the channel estimation process is complete. And according to the G.992.3 standard, the CO(ONU) continues the C-REVERB3 sequence for a number of frames up to 64 frames following receipt of this transition signal from the CPE (RT), followed by transmission of the C-QUIET5 sequence. But according to the preferred embodiment of the invention, the number of C-REVERB3 frames transmitted by the CO(ONU) following the R-QUIET5 to R-REVERB3 transition will depend on the frame timing of the specific port involved relative to other ports, and will depend on the length, in data symbols, of the cyclic prefix that will eventually be applied. The frame at which the cyclic prefix is first applied can be delayed by transmitting a larger number of C-REVERB3 frames; conversely, the frame at which the cyclic prefix is first applied can be advanced by transmitting fewer C-REVERB3 frames at this initialization stage. The process carried out by the CO(ONU) DSL modem to derive the number of C-REVERB3 symbols to be transmitted following the transition from R-QUIET5 to R-REVERB3, according to the preferred embodiment of the invention, will be described in further detail below.

On the CPE (RT) side, the R-REVERB3 sequence is carried out for a fixed number of frames (e.g., 64 frames), and is followed by the R-ECT sequence, and other sequences that remain in the transceiver training phase of the initialization. Similarly, the CO(ONU) also continues the initialization process. Later in the sequence, as shown in FIG. 7, the transceiver training phase of initialization terminates, with the CO(ONU) transmitting the C-SEGUE1 sequence (ten frames in length) and the CPE (RT) transmitting the R-SEGUE1 sequence (also ten frames long). The channel analysis phase of initialization then begins, with the CO(ONU) transmitting the C-MSG1 sequence and the CPE (RT) transmitting the R-REVERB5 sequence. These sequences are each transmitted with cyclic prefices prepended to each frame, in the conventional manner.

Accordingly, as shown in FIG. 7, the timing with which the channel analysis phase and thus at which the cyclic affices are affixed to the transmitted frames depends on the number of frames transmitted prior to this point, given the sequential nature of the initialization process. And therefore, by controlling the number of frames transmitted during an earlier phase of initialization, the CO(ONU) can control the point in time at which the cyclic prefix is first transmitted. According to the preferred embodiment of the invention, this control is effected with knowledge of the specific one of the multiple ports that is being initialized, and its relative timing relative to the other ports corresponding to DSL loops supported from the same modem.

Alternative initialization sequences are also available for use in determining the timing at which the cyclic affix is first introduced into the transmission. For example, under the G.992.3 ADSL standard incorporated above, the length in frames of the C-TREF1, C-QUIET1, C-QUIET3, and C-QUIET4 sequences can alternatively adjusted, or adjusted in addition to the length of the C-REVERB3 sequence as described above. All of these sequences occur in advance of the initiation of the cyclic affices to the transmitted frames, and all have a variable length in number of frames that can be controlled in this manner.

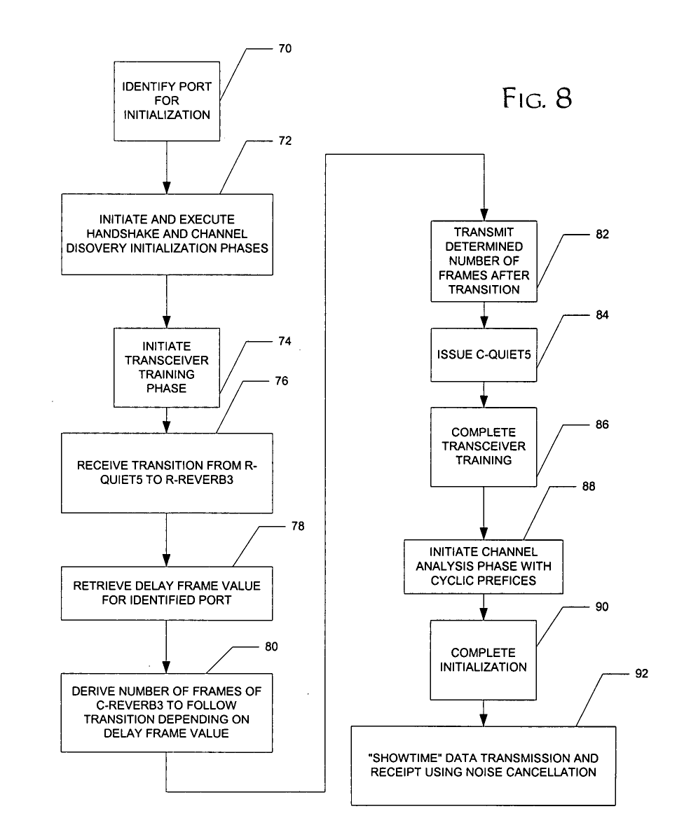

Referring now to FIG. 8, the operation of CO DSL modem 21 in initializing a DSL session, including the specific operations involved in establishing the number of frames of C-REVERB3 to be transmitted after the transition from R-QUIET5 to R-REVERB3 for a given port, according to an example of the preferred embodiment of the invention under the G.992.3 standard incorporated above, will be described. It is contemplated that digital transceiver 43 of DSL modem 21 (FIGS. 3 and 4) will have sufficient computational capacity to perform and control these operations; alternatively, other logic circuitry in DSL modem 21 may be provided to provide these control functions. In process 70, DSL modem 21 identifies the port (P0 through P3) for which a DSL communications session is to be initialized; by identifying this port, it is contemplated that the relative delay, before enabling cyclic extensions, of this port relative to the other ports supported by DSL modem 21 is either known or can be calculated. The conventional initialization phases of handshake and channel discovery are then performed between DSL modem 21 and the corresponding CPE in process 72. In process 74, DSL modem 21 then initiates the transceiver training initialization phase. Transceiver training is then carried out by the communicating CO/ONU and CPE transceivers according to the G.992.3 standard, until (for purposes of this exemplary implementation of the invention) the CPE (RT) completes its downstream channel estimation, and makes the transition from transmitting the R-QUIET5 sequence to transmitting the R-REVERB3 sequence.

In response to receiving this transition signal, DSL modem 21 at the CO/ONU retrieves a value corresponding to a number of remaining frames of the C-REVERB sequence for the identified modem port, in process 78. This value may be pre-calculated and retrieved from memory, in process 78, or may be calculated in real-time if preferred. In either case, the relative time delay among the various ports of DSL modem 21 must be either known, or measurable and derivable. After retrieval of this value, in process 80, DSL modem 21 determines the number of frames of C-REVERB3 are to follow the transition from R-QUIET5 to R-REVERB3, using the retrieved value. For the example discussed above and shown in FIG. 5, a table in memory may include the following values for relative frame delays among the supported ports:

| | Delay relative | Remaining C-REVERB3 |
|---|---|---|
| | to Port P3 | frames |
| Port P0 | −¾ (− 12/16) frame | M-12 frames |
| Port P1 | −½ (− 8/16) frame | M-8 frames |
| Port P2 | −¼ (− 4/16) frame | M-4 frames |
| Port P3 | 0 frame | M-0 frames |

In this example, the relative delay required refers to the value retrieved in process 78 that corresponds to the relative delay (i.e., the fractional frame relative delay times the CP fractional length) among the various ports, using port P3 as the reference in this case. Of course, any of the ports may serve as the reference port, with the relative delay values adjusted accordingly. The remaining C-REVERB3 frames derived in process 80 results from the combination of the M frames that would be transmitted following the transition in any case, plus the relative delay values retrieved in process 78. Because the sequence of C-REVERB3 frames is transmitted prior to the initiation of the cyclic prefix, a fewer number of remaining C-REVERB3 frames will advance the initiation of the cyclic prefix, while a greater number of remaining C-REVERB3 frames will delay the initiation of the cyclic prefix. Accordingly, the cyclic prefix should be initiated earlier for those ports that lead in time, and later for the lagging ports. And accordingly, the number of remaining C-REVERB3 frames should be fewer for leading ports and greater for lagging ports. The above table reflects this approach. Again, in this example the numbers of the “Remaining C-REVERB3 frames” in the above table refer to modulo-16 values, because the cyclic extension in this example is one-sixteenth of the length of the data symbols in the frame. In other applications in which the cyclic extensions are 1/k of the length of the data symbols in the frame, the corresponding numbers of remaining frames will be modulo-k.

In general, of course, the relative delay, in frames, will depend on the parameters of the ports and the cyclic affix length. It is contemplated that those skilled in the art having reference to this specification can readily derive the relative delay, following the examples described above. In addition, while processes 78 and 80 are shown in FIG. 8 as following the receipt of the R-QUIET5 to R-REVERB3 transition, these processes can be executed at any time after handshake (process 72), so long as the number of frames to be transmitted before initiating cyclic extensions is derived in time. Indeed, it is contemplated that there is no additional information that is gathered during the initialization processes up to this point that is required in order for the derivation of this number of frames to be transmitted, and as such it may be preferable to execute processes 78 and 80 as soon as practicable.

As shown in FIG. 8, process 82 is executed, by way of which the CO (ONU) transmits the number of remaining C-REVERB3 frames derived in process 80, following which it issues the C-QUIET5 sequence in process 84, and will then continue the remaining operations in transceiver training in the conventional manner. Transceiver training is completed in process 86, as shown in FIG. 8.

Upon initiation of the channel analysis phase of initialization, in process 88, a cyclic prefix is prepended to each frame as transmitted, as described above. This point in the process corresponds to the generation of the C-MSG1 sequence (and the R-REVERB5 sequence) as shown in FIG. 7. The timing of these frames with the cyclic prefices is thus established by the derivation and transmission of the number of remaining C-REVERB3 frames, in processes 80, 82, respectively. Initialization is completed in process 90 as conventional, and the “showtime” phase commences in process 92, preferably using a noise cancellation process to eliminate coherent noise over multiple loops, for example by using a vector transmission concept as described in Ginis et al., “Vectored Transmission for Digital Subscriber Line Systems”, Journal on Selected Areas in Communications, Vol. 26, No. 5 (IEEE, June 2002), pp. 1085-1104; Ginis et al., “Vectored-DMT: A FEXT Canceling Modulation Scheme for Coordinating Users”, presented at IEEE International Conference on Communication, Vol. 1 (IEEE, June 2001), pp. 305-309; and in U.S. Provisional Application No. 60/632,270 filed Dec. 1, 2004 (commonly assigned herewith), all of which are incorporated herein by this reference. The noise cancellation techniques contemplated for use in connection with this invention are preferably applied in the form of precoding or other transmit filtering, considering that the relative CPE (RT) equipment for each of the loops in the common binder driven by ports P0 through P3 will typically be deployed at different locations. Conversely, if the receivers are co-located with one another, noise cancellation can be applied at the receiving end.

It has been observed, according to this invention, that significant signal-to-noise improvement can be achieved by the synchronizing approach of the preferred embodiment of the invention, when coupled with noise cancellation as described above. For example, for a given fixed loop length of 10 kft for a 2-line bonding example, the data rate has been observed to improve from about 5 Mbits/sec for the case with no synchronization and no noise cancellation to about 7 Mbits/sec when the frames of the two lines are synchronized as described above and the vectoring noise cancellation approach described above applied to the data. Conversely, for a given data rate of 10 Mbits/sec, the use of this preferred embodiment of the invention has been observed to lengthen the minimum loop length from 7.6 kft to 8.7 kft, which is of course a 14% radial increase in coverage.

And in addition, this invention is capable of providing such dramatic improvements in data rate or coverage in a manner that is perfectly compatible with existing ADSL standards, such as the G.992.3 standard mentioned and incorporated herein. As such, retrofit of existing equipment is contemplated to be quite easy and efficient.

In addition, it is contemplated that this invention can reduce the phase differential (frame mis-synchronization) among the multiple ports to nearly zero, particularly for modem DSL transceiver chipsets in which the relative transmission timing of the supported multiple ports can be closely controlled. Such close synchronization among the ports will serve to enhance the benefits of the coherent noise cancellation techniques to be applied.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

1. A method of initializing digital subscriber line communications for a first one of a plurality of ports supported by a modem, comprising the steps of:
determining a relative timing delay for the first port relative to at least one other of the plurality of ports;
initializing a communications session with a remote terminal by transmitting a plurality of frames that do not have a cyclic affix appended thereto;
selecting a frame at which a cyclic affix of known length is to be appended, based on the relative timing delay; and
after the selecting step and during the initializing step, and beginning with the selected frame, transmitting a plurality of frames to which a cyclic affix of a known length is appended.

2. The method of claim 1, wherein the initializing step comprises:
transmitting known sequences of frames to the remote terminal over a first twisted-pair wire facility;
receiving sequences of frames from the remote terminal over the first twisted-pair wire facility.

3. The method of claim 2, further comprising:
receiving a first frame of a first sequence from the remote terminal;
then transmitting a variable number of frames of a second sequence responsive to receiving the first frame of the first sequence from the remote terminal, the variable number of frames determined responsive to the selecting step.

4. The method of claim 3, wherein the frames of the second sequence do not have a cyclic affix appended thereto.

5. The method of claim 4, wherein the step of transmitting a plurality of frames to which a cyclic affix of a known length is appended is performed after the step of transmitting the variable number of frames of the second sequence.

6. The method of claim 1, wherein the frames are discrete multitone modulated frames.

7. The method of claim 1, wherein the initializing step comprises:
transmitting known sequences of frames to the remote terminal over a first twisted-pair wire facility;
receiving sequences of frames from the remote terminal over the first twisted-pair wire facility;
wherein the at least one other of the plurality of ports transmits and receives digital subscriber line communications over a second twisted-pair wire facility.

8. The method of claim 7, further comprising:
after the step of transmitting the plurality of frames to which a cyclic affix of a known length is appended, then transmitting payload data arranged in frames, each frame having a cyclic affix appended thereto over the first and second twisted-pair wire facilities; and
during the step of transmitting payload data, applying noise cancellation techniques to the payload data for the first and second twisted-pair wire facilities.

9. A digital subscriber line modem, comprising:
a host interface, for receiving data from and providing data to a host;
a digital transceiver, coupled to the host interface, comprising:
a digital processing subsystem for digitally processing data received at the host interface for transmission and for digitally processing data to be provided to the host interface;
a modulator coupled to the digital processing subsystem;
a demodulator coupled to the digital processing subsystem;
a plurality of transmit/receive ports, coupled to the modulator and demodulator;
a plurality of analog front ends, each coupled to one of the plurality of transmit/receive ports; and
control circuitry for controlling the initializing of a digital subscriber line communications session over a first transmit/receive port, the control circuitry for performing a sequence of operations comprising:
determining a relative timing delay for the first transmit/receive port relative to the other transmit/receive ports;
initializing a communications session with a remote terminal by transmitting, from the first transmit/receive port, a plurality of frames that do not have a cyclic affix appended thereto;
selecting a frame at which a cyclic affix of known length is to be appended, based on the relative timing delay; and
beginning with the selected frame, then transmitting, from the first transmit/receive port, a plurality of frames to which a cyclic affix of a known length is appended.

10. The modem of claim 9, wherein the control circuitry is for controlling the initializing of a digital subscriber line communications for each of the plurality of transmit/receive ports.

11. The modem of claim 9, wherein the digital transceiver comprises the control circuitry, and further comprises post-modulation circuitry for appending cyclic affices to data frames.

12. The modem of claim 9, wherein a first twisted-pair wire facility is coupled to the first transmit/receive port, and to a remote terminal.

13. The modem of claim 12, wherein the sequence of operations further comprises:
receiving a first frame of a first sequence from the remote terminal over the first twisted-pair wire facility;
then transmitting a variable number of frames of a second sequence responsive to receiving the first frame of the first sequence from the remote terminal, the variable number of frames determined responsive to the selecting operation.

14. The modem of claim 13, wherein the frames of the second sequence do not have a cyclic affix appended thereto.

15. The modem of claim 14, wherein the control circuitry controls the transmitting of a plurality of frames to which a cyclic affix of a known length is appended to occur after the transmitting of the variable number of frames of the second sequence.

16. The modem of claim 9, wherein the frames are discrete multitone modulated frames.

17. The modem of claim 9, wherein each of the plurality of transmit/receive ports is coupled to an associated one of a plurality of twisted-pair wire facilities;
and wherein the plurality of twisted-pair wire facilities are contained within a common binder.

18. A method of initializing digital subscriber line communications for a first one of a plurality of ports supported by a modem, comprising the steps of:
identifying a relative timing delay for the first port relative to at least one other of the plurality of ports;
executing a first portion of an initialization session with a remote terminal, the first portion comprising transmitting a plurality of frames that do not include a cyclic extension;
determining the duration, in frames, of the first portion of the initialization session, based on the relative timing delay; and
after the determining step, executing a second portion of the initialization session, the second portion comprising transmitting a plurality of frames including a cyclic extension of a known length.

19. The method of claim 18, wherein the step of executing the first portion of the initialization session further comprises:
receiving a transition indication from the remote terminal;
then transmitting a variable number of frames that do not include a cyclic extension responsive to receiving the first frame of the first sequence from the remote terminal, the variable number of frames determined responsive to the determining step.

20. The method of claim 18, wherein the step of executing the first portion of the initialization session comprises:
transmitting known sequences of frames to the remote terminal over a first twisted-pair wire facility;
receiving sequences of frames from the remote terminal over the first twisted-pair wire facility;
wherein the at least one other of the plurality of ports transmits and receives digital subscriber line communications over a second twisted-pair wire facility;
and further comprising:
after the step of executing the second portion of the initialization session, transmitting payload data arranged in frames, each frame including a cyclic extension, appended, over the first and second twisted-pair wire facilities; and
during the step of transmitting payload data, applying noise cancellation techniques to the payload data for the first and second twisted-pair wire facilities.
